(19) United States
(12) Patent Application Publication
(10) Pub. No.: US 2024/0149188 A1
(43) Pub. Date: May 9, 2024

(54) METHODS AND SYSTEMS FOR SOLID PHASE EXTRACTION

(71) Applicant: The USA, as represented by the Secretary, Department of Health and Human Services, Bethesda, MD (US)

(72) Inventors: Alexander Glenn GODFREY, Carmel, IN (US); Meghav VERMA, Gaithersburg, MD (US); Vishakha GOYAL, Gaithersburg, MD (US); Pranav BENDE, University Park, MD (US); Linus Eric WALLGREN, Chevy Chase, MD (US); James Cullen KLEIN, Rockville, MD (US)

(21) Appl. No.: 18/550,239

(22) PCT Filed: Mar. 16, 2022
(86) PCT No.: PCT/US22/20596

§ 371 Date: Sep. 12, 2023

Related U.S. Application Data
(60) Provisional application No. 63/161,851, filed on Mar. 16, 2021.

(51) Int. Cl. B01D 15/24; G01F 23/292

(52) U.S. Cl. CPC B01D 15/24; G01F 23/292

(57) ABSTRACT

Methods and systems for solid phase extraction procedures are provided. Methods and systems of the present disclosure provide for improved accuracy, automation, and ease of use of various solid phase extraction procedures and other processes to be performed in a laboratory setting. Systems and methods for fluid flow regulation and detection are disclosed.

This International Application filed under the Patent Cooperation Treaty claims the benefit of priority of U.S. Provisional Patent Application 63/161,851, filed Mar. 16, 2021, the entire disclosure of which is hereby incorporated by reference.

### FIELD

The present disclosure relates generally to methods, systems and devices for use in various chemical preparation, extraction and related processes including but not limited to solid phase extraction. In some embodiments, methods, systems and devices of the present disclosure relate to the synthesis of a novel molecule and separation of an expected product. However, embodiments of the present disclosure are contemplated for use with various processes and applications. The present disclosure and various inventions disclosed herein are not limited to solid phase extraction or even benchtop chemistry.

### BACKGROUND

In many laboratory and benchtop chemistry applications, execution of a chemical reaction targeting the synthesis of a novel molecule is followed by an isolation step often referred to as a “workup.” A workup typically involves a process that precedes a purification step that may be conducted by chromatography or re-crystallization, for example. Workup procedures may include an extractive process of partitioning a reaction mixture with an addition volume of immiscible liquids such as water and/or organic solvents (e.g. ethyl ether or ethyl acetate). However, many workup procedures do not provide material of sufficient quality for the final synthetic target or an intermediate for use in further synthetic efforts. A process of solid phase extraction (hereafter “SPE”) can provide an alternative for reaction workup and supply material of superior quality relative to known extractive procedures in less time, thereby improving efficiency.

SPE as a technique suffers from a general dearth of hardware and methods for rapid and efficient execution of SPE-based workflows. Existing hardware for SPE operations is generally limited to small scale operations. Examples of such devices include those shown and described in U.S. Pat. No. 7,610,941 to Kubacki and U.S. Pat. No. 10,495,614 to Pohl et al., the entire disclosures of which are hereby incorporated by reference. Limitation of known devices include, for example, handling only aqueous samples, supporting parallel separation on very similar or the same matrices, and internal plumbing that is not generally suitable for a wide range of chemical reagents and solvents.

### SUMMARY

Accordingly, there has been a long-felt but unmet need to provide improved methods and systems for SPE. While various embodiments of the present disclosure are well suited for and contemplated for use with SPE, it will be recognized that the present disclosure is not limited to SPE processes. It is contemplated that various benchtop chemistry and other methods and processes may utilize objects, features and various inventive aspects of the present disclosure.

It is an object of embodiments of the present disclosure to provide for and accommodate the demands of chemistry workflows that require samples to be handled in a singular and rapid, efficient manner.

In certain embodiments, devices and systems are provided that accommodate and support different cartridge and container sizes. Devices and systems of the present disclosure are operable to accommodate up to 50 mL of liquid fractions in tubes (e.g., 25×150 mm tubes) provided in a modular rack. Racks of the present disclosure are contemplated as housing or holding multiple fractions. In some embodiments, racks of the present disclosure are operable to receive at least four fractions.

In various embodiments, methods and systems are provided that comprise a software-controlled sequence under optimized conditions that only require one set of four fractions to complete an unattended run, but the unit can accommodate the collection of an indefinite number of fractions by queuing the user in a semi-automated manner to swap in an additional array of empty tubes as each set of fractionations is completed. Allowing a fraction rack of empty fractions to be swapped in this manner allows for more flexible application of separations when edge cases are encountered. The swappable fraction racks also open up the opportunity for robotic swapping of the racks holding such fraction vessels to be considered in the course of integrating the instrument onto a more complex platform.

In various embodiments, devices are operable to house a plurality of fluids or solvents in a plurality of reservoirs. In particular embodiments, systems are provided that are operable to provide different mixtures of solvent; provide optical recognition algorithm(s); perform corrective action if and when headspace overfill is detected; monitor and account for clogging in a system; and purge lines and solvents to a waste stream collection mechanism.

It is an object of the present disclosure to provide a system and instrumentation with a small footprint that is operable to provide precise rapid workup of chemical reactions in a relatively small space. It is a further object of the present disclosure to provide a modular system that permit fully manual or fully automated functionality and portability. It is yet another object of the present disclosure to provide a system with enhanced mixing abilities and wherein the system provides mixtures of various solvents stored our housed within the system. It is yet another object of the present disclosure to provide a system with automated solvent delivery. It is a further object of the present disclosure to provide a pressure-based elution of solvents wherein efficient elution of solvent through a SPE cartridge is provided. In some embodiments, automatic breakthrough detection is provided to detect the completion of solvent elution using air flow sensing.

Embodiment of the present disclosure contemplate the provision of various materials including, for example, polylactic Acid (PLA) for parts which do not require chemical compatibility; polypropylene (PP) for parts which require chemical compatibility; thermoplastic polyurethane (TPU) for elastic parts; polyether ether ketone (PEEK) for strong parts with chemical compatibility; sealing plug: conical design to seal cartridges of varied diameters, use of 3D printing to print the mounting flange (using PLA or PEEK) and sealing part (using TPU).

In some embodiments, methods and systems for fluid level detection are provided to monitor the liquid level in the cartridge and avoid overfilling. Innovative techniques like real time image processing with a camera using conventional computer vision algorithms and machine learning are contemplated and disclosed herein. Additional techniques such as laser sensing and ultrasound sensing are also contemplated.

In some embodiments, systems comprise software and user-interface to allow a user to select solvent(s), volume(s), and/or a number of fraction collections to be performed and to automate the process of extraction or SPE. A flow sensor (e.g., air flow sensor) is contemplated for monitoring for breakthrough.

In one embodiment, a system for performing solid phase extraction procedures is provided. The system comprises a cartridge for receiving at least one of a solid and a liquid, the cartridge being selectively provided on and supported by a support member. A dispensing device is provided that is operable to dispense a fluid to an interior volume of the cartridge. A sealing member is provided that operable to provide a substantially gas-impermeable seal to a proximal end of the cartridge. A plurality of fluid reservoirs are provided that are each operable to house and dispense a fluid. A pump is provided that is operable to convey fluid from the plurality of fluid reservoirs to the dispensing device. A translatable rack houses a plurality of containers (e.g., fraction containers) that are operable to receive fluid from the cartridge.

In various embodiments, methods of SPE are provided. In one embodiment, a method of SPE is provided that comprises providing an empty cartridge and a fraction carrier comprising a plurality of empty fraction vessels. The presence of the cartridge and fraction vessels are detected, and the system is indexed to the first fraction vessel. A sample is introduced into the cartridge and a signal is input into the system to initiate a process. The cartridge is preferably pressurized to clear a headspace of the cartridge. An internal pressure value of the cartridge is monitored to detect process status and completion.

In one embodiment, a method of detecting fill level of a container is provided. The method comprises: providing a container having a volume; determining a maximum fill level of the container; providing a camera; capturing images of the container using the camera; providing a fluid to the volume of the container; performing an edge detection technique to the images; applying a filter to the images; and identifying an actual fill level of the container.

These objectives and embodiments are disclosed in more detail herein. It should be recognized that various inventive features and aspects provided in the present disclosure are not limited to the embodiment(s) in which they are depicted or described. Indeed, it is contemplated that certain features shown and described with respect to one embodiment (e.g., an air flow sensor or waste collection system) may be employed in another embodiment even if such a specific combination is not shown and described.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In addition, the materials, methods, and examples are illustrative only and are not intended to be necessarily limiting.

### DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

FIG. 1 is a perspective view of a system according to one embodiment of the present disclosure.

FIG. 2 is a perspective view of a system according to one embodiment of the present disclosure.

FIG. 3 is a perspective view of a plurality of components of the present disclosure according to an embodiment of the present disclosure.

FIG. 4 is a perspective view of a plurality of components of the present disclosure according to an embodiment of the present disclosure.

FIG. 5 is a rear perspective view of a plurality of components of the present disclosure according to an embodiment of the present disclosure.

FIG. 6A is a perspective view of a component of embodiments of the present disclosure.

FIG. 6B is a perspective view of components of embodiments of the present disclosure.

FIG. 6C is a perspective view of components of embodiments of the present disclosure.

FIG. 7 is a schematic of a system according to one embodiment of the present disclosure.

FIG. 8 is an elevation view of components of a system according to one embodiment of the present disclosure.

FIG. 9 is a perspective view of components of a system according to one embodiment of the present disclosure.

FIG. 10 is a perspective view of components of a system according to one embodiment of the present disclosure.

FIG. 11 is a perspective view of components of a system according to one embodiment of the present disclosure.

FIG. 12 is a view of a user-interface according to one embodiment of the present disclosure.

FIG. 13 is a waveform plot showing data of one embodiment of the present disclosure.

FIG. 14A is a view of a container and its headspace according to one embodiment of the present disclosure.

FIG. 14B is a view of a container and its headspace according to one embodiment of the present disclosure.

FIG. 14C is a view of a container and its headspace according to one embodiment of the present disclosure.

FIG. 15A is a view of a container and a certain fill level according to one embodiment of the present disclosure.

FIG. 15B is a view of a container and a certain fill level according to one embodiment of the present disclosure.

FIG. 15C is a view of a container and a certain fill level according to one embodiment of the present disclosure.

FIG. 16A is bottom perspective view of a component according to one embodiment of the present disclosure.

FIG. 16B is a top perspective view of the component of FIG. 16A.

FIG. 17 is a perspective view of a component according to one embodiment of the present disclosure.

FIG. 18 is a perspective view of a component according to one embodiment of the present disclosure.

FIG. 19 is a cross-sectional elevation view of the component of FIG. 18.

FIG. 20 is a perspective view of a component according to one embodiment of the present disclosure.

FIG. 21 is a bottom view of the component of FIG. 20.

FIG. 22 is a top perspective view of a dispensing and pouring system according to an embodiment of the present disclosure.

FIG. 23 is a bottom perspective view of the dispensing and pouring system according to the embodiment of FIG. 22.

FIG. 24 is a perspective view of a system according to an embodiment of the present disclosure.

FIG. 25A is a perspective view of a dispensing and pouring system according to an embodiment of the present disclosure.

FIG. 25B is a perspective view of the system of the embodiment of FIG. 25A.

FIG. 25C is a perspective view of the system of the embodiment of FIG. 25A.

FIG. 26 is a perspective view of a system according to an embodiment of the present disclosure.

FIG. 27A is a perspective view of a dispensing and pouring system and a container according to an embodiment of the present disclosure.

FIG. 27B is a perspective view of the dispensing and pouring system according to the embodiment of FIG. 27A.

FIG. 28A is a side view of a dispensing and pouring system according to an embodiment of the present disclosure.

FIG. 28B is a side view of a dispensing and pouring system according to the embodiment of FIG. 28A.

FIG. 28C is a side view of a dispensing and pouring system according to the embodiment of FIG. 28A.

FIG. 29 is a schematic of a system according to one embodiment of the present disclosure.

### DETAILED DESCRIPTION

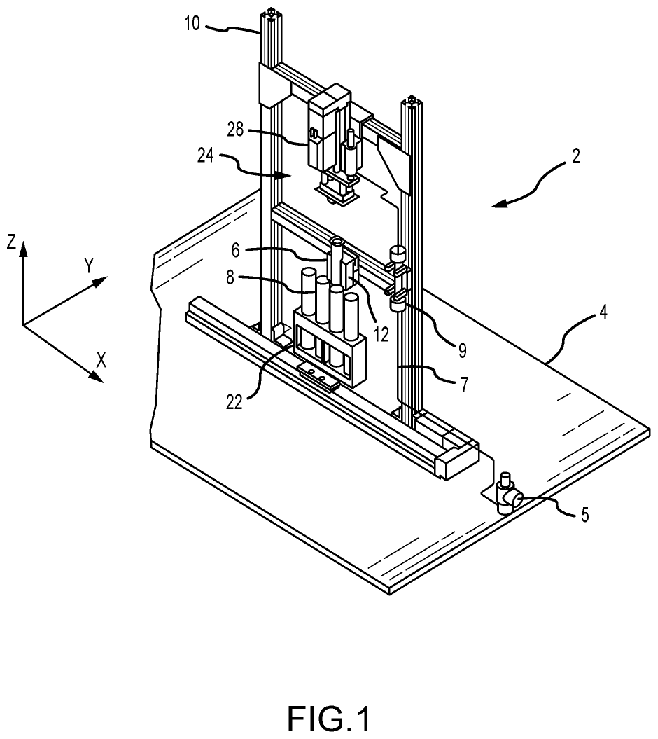

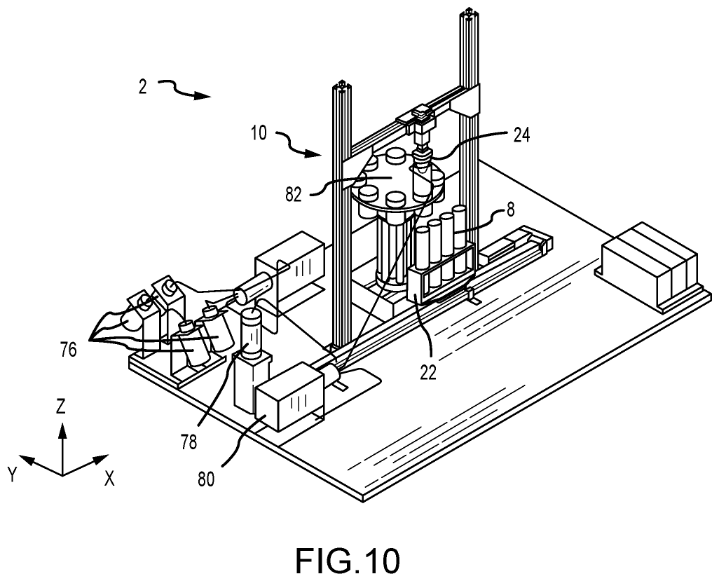

FIG. 1 is a perspective view of a system 2 according to one amendment of the present disclosure. The system 2 is contemplated as comprising a benchtop system suitable for research and production operations on relatively small scales. It will be recognized, however, that no limitation is provided herewith regarding the specific size or intended use of systems shown and described herein. Indeed, the system shown in FIG. 1 and other Figures is contemplated as being scaled up or down as needed to accommodate different processes, uses, and applications. It is also contemplated that various embodiments of the present disclosure are provided as “manual” loading systems wherein solvent and materials are manually inserted and loaded into a cartridge 6. In other embodiments, the loading of contents (e.g., solvents) into a cartridge is performed automatically or semi-automatically by the provision and use of a pump (FIG. 10, for example). It should be recognized that various embodiments and systems can be operated in these different modes. For example, a pump and related features (e.g., storage container(s), conduit(s)) is contemplated as being provided with the system and embodiment of FIG. 1. In addition, embodiments depicting a pump (for example) are contemplated as being modified or adapted to be used with manual SPE and similar processes. In general, it should be noted that various features disclosed, depicted and described with respect to one or more embodiments may be provided in other embodiments of the present disclosure even if such combination(s) are not specifically shown or described.

As shown in FIG. 1, the system 2 is provided at least partially on a benchtop 4 or platform for supporting the system. The system 2 comprises at least one cartridge 6. The cartridge preferably comprises a replaceable cartridge for conveying materials (e.g., fluids) to one or more fraction containers 8. As shown in FIG. 1, the fraction containers 8 are provided in a linear fraction assembly. Alternative arrangements including, for example, fractions provided in grid and circular arrangements are also contemplated.

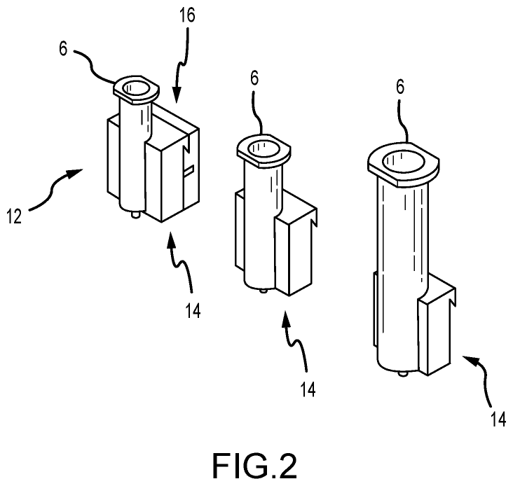

A support assembly 10 is provided that is contemplated as being formed from and comprising various rigid support elements. For example, the support assembly of FIG. 1 is shown as comprising a plurality of aluminum support members that are sized and operable to receive and support various components of the present disclosure. Although not shown in FIG. 1, it is contemplated that various components of the present disclosure including but not limited to the support assembly 10 may be housed or contained within a body or housing such that the components are concealed and protected. Various support members suitable for supporting the features and functions shown herein are contemplated and no limitation with respect to the particular frame or support assembly 10 is provided. A cleat member 12 is provided in FIG. 1 that is operable to selectively receive and support the cartridge 6. In the embodiment of FIG. 1, the cleat member 12 is depicted as a French cleat which is shown and described in more detail with respect to FIG. 2.

The system of FIG. 1 comprises a cartridge 6 for receiving and ultimately dispensing a fluid to containers or vials 8 provided in a fraction rack 22. As shown, the system 2 further comprises a dispensing device 24. In some embodiments, the dispensing device 24 is operable to receive and dispense a fluid (e.g., a solvent) from a conduit (not shown in FIG. 1) connected to a fluid source. In the embodiment of FIG. 1, it is contemplated that an open end of the cartridge 6 is manually provided with a solvent directly by a user.

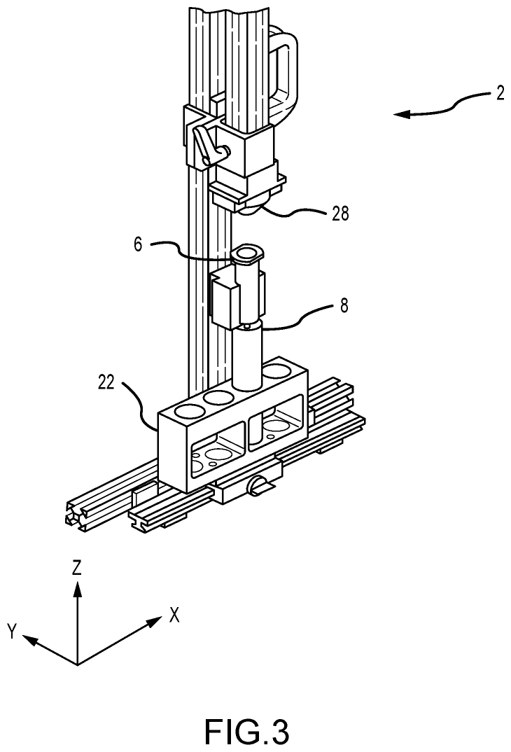

The dispensing device 24 further comprises a linear actuator to adjust a position of at least portions of the dispensing device. In some embodiments, the dispensing device 24 further comprises a plug element (28 in FIG. 3) that is in communication with the linear actuator such that the device is operable place the plug in a sealing arrangement with the proximal end of the cartridge 6.

The “breakthrough” of the SPE process is characterized by a sudden drop of pressure in the headspace of the cartridge and a concomitant increase in gas flow through the system and out the exit nozzle of the cartridge. Although it is possible to measure an inflection in the change of pressure to mark this transition, it is possible and desirable to detect changes in gas flow with much greater sensitivity across a broader range of differing flow characteristics through the media of the SPE.

As shown in FIG. 1, the system 2 is provided such that the cartridge 6, the dispensing device 24, and the fraction rack 22 are all translatable with respect to one another in at least the X-axis. The dispensing device 24 comprises components that are also translatable or moveable in the Z-axis.

The embodiment of FIG. 1 further comprises an air inlet 5 that is contemplated as being connected to or provided with a supply of gas or fluid (e.g., ambient air or nitrogen). A fluid line 7 is provided to convey fluid to the dispensing device 24 and ultimately provide a pressure to an internal volume of a cartridge 6. An airflow sensor 9 (e.g., anemometer) is provided and is operable to detect and evaluate flow characteristics of the fluid in the line 7 and/or cartridge 6.

FIG. 2 is a perspective view of a plurality of cartridges 6 and cleat members 12. As shown, the cleat member 12 generally comprises two components including a holder 14 and a receiving portion 16 upon which the holder 14 resides. In various embodiments, the holder 14 is secured to the receiving portion 16 by gravity alone. In other embodiments, magnetic elements are contemplated to connect the cartridge and/or holder 14 to the receiving portion 16. The holder 14 comprises a concave receiving area for a cartridge 6. A plurality of holders 14 are contemplated for accommodating different sized cartridges, and each of the holders 14 are preferably capable of being received by a receiving portion 16. The receiving portion may be slidable along a portion of a frame member of the system and/or may be mounted to a translatable element. The holder 14 is operable to be quickly and easily replaced, with the receiving portion being preferably operable to receive holders 14 and associated cartridges of multiple different sizes.

FIG. 3 is a perspective view of a system according to another embodiment of the present disclosure. As shown, the system 2 comprises a cartridge 6 for positioning relative to one or more fractions 8 provided in a fraction rack 22. A plug 28 is provided that is operable to be manually displaced in at least the Y-axis and to substantially seal the cartridge 6. The cartridge 6 is secured by a cleat member such as that shown and described with respect to FIG. 2. A vertical position of the cartridge can be adjusted in the Z-axis. The fraction rack 22 is operable to be translated in at least the X-axis and relative to the cartridge. In the embodiment of FIG. 3, it is contemplated that the system 2 is provided as a manual system wherein a user manually loads a sample and a solvent into the cartridge 6. The user will also manually position the plug 28 to begin a process.

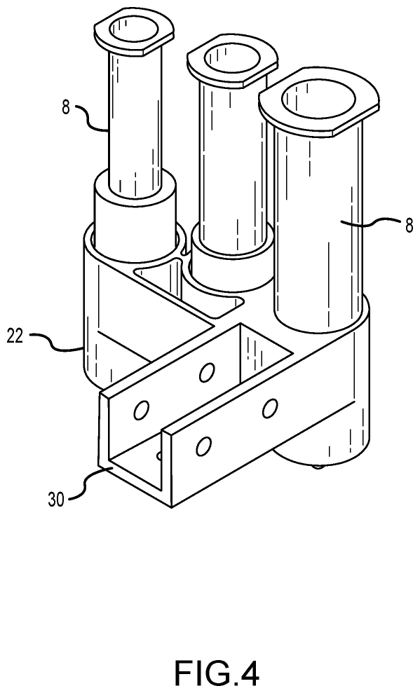

FIG. 4 is a perspective view of a fraction rack 22 according to one embodiment of the present disclosure. As shown, the rack 22 comprises receiving areas for receiving fraction vessels 8 of different sizes or diameters. A mounting bracket or arm 30 is provided to secure the rack 22 to additional system components.

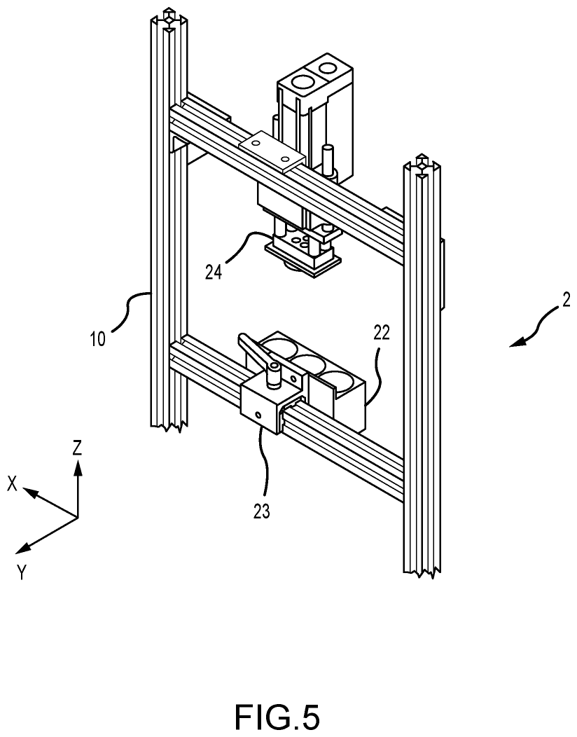

FIG. 5 is a perspective view of a system 2 according to another embodiment of the present disclosure. As shown, the system 2 comprises a frame member 10 operable to support system components. As shown, the system comprises a dispensing device 24 that seals on the top of an SPE cartridge (not shown in FIG. 5) and a fraction rack 22 operable to receive and support a plurality of vessels (not shown in FIG. 5). The fraction rack 22 is adjustable in at least a horizontal direction (X-axis) and the dispensing device 24 is operable to dispense a fluid (e.g., air, nitrogen and/or solvent) and to seal a cartridge using a plug. The position of the dispensing device 24 is contemplated as being fixed but adjustable in the X-axis, and at least a portion of the dispensing device 24 is moveable in a vertical (Z-axis) direction. For example, the plunger may be lowered and brought into contact with a cartridge to provide a seal at a proximal end of the cartridge. The fraction rack 22 comprises a fastener 23 such that the position of the rack 22 in the X-axis can be quickly adjusted and fraction vessels can be quickly repositioned relative to the dispensing device 24.

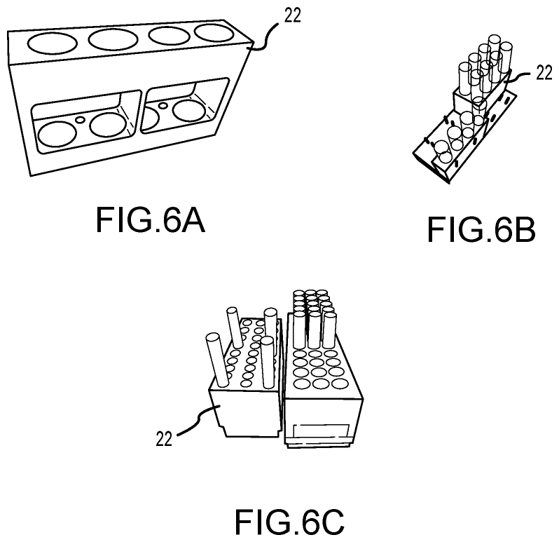

FIGS. 6A-6C depict fraction racks 22 operable for use with embodiments of the present disclosure. As shown, fractions racks 22 are contemplated that house and support vials or containers for use during procedures. The racks 22 are contemplated as comprising 3D-printed racks and preferably comprise chemically-resistive material(s) that allow rapid assembly and disassembly to fit within the footprint of any number of commercially-available rack formats. Modular racks are provided such that the tubes are presented at exactly the same height as the tubes in racks of commercial origin. The racks 22 are preferably sized and formatted such that they may be combined and assembled with additional racks to provide a feature that fits within the footprint of commercial rack therefore readily accommodated by existing hardware including but not limited to known liquid handler components. Thus, a setup of 6 ‘mini-racks’ is contemplated as holding and accommodating up to 24 tubes in area of approximately 11.25 in ×3.9 in ×3.575 in.

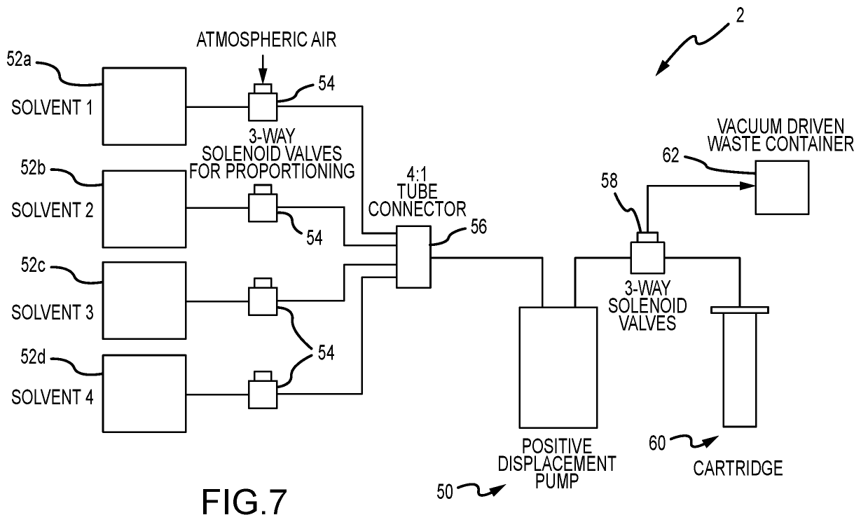

FIG. 7 is a schematic view of a system 2 according to one embodiment of the present disclosure. As shown, the system 2 comprises a pump 50 operable to convey fluid(s) between various components of the system 2. A plurality of reservoirs 52a, 52b, 52c, 52d are shown. Although four reservoirs are shown in FIG. 7, no limitation with respect to the size and number of reservoirs is provided. The reservoirs 52 are contemplated as comprising fluid reservoirs for storing and selectively dispensing a fluid. For example, in some embodiments, a solvent is stored in each of the plurality of reservoirs. Valves 54 are provided to regulate the flow of solvent from the reservoirs 52. In some embodiments, a three-way solenoid valve is provided to control fluid from each of the reservoirs. A tube connector 56 or similar union is provided, and the pump 50 is operable to draw fluid from the reservoirs 52. While solenoid valves are shown and contemplated with respect to FIG. 7, it will be recognized that the present disclosure is not limited to solenoid valve and various other valve types and arrangements may be provided while still accomplishing the objectives of the present disclosure. In preferred embodiments, however, it is contemplated that solenoid valves are well suited for certain embodiments and applications of the present disclosure and facilitate automation of a system.

In operation, the pump 50 is operable to draw fluid from one or more reservoirs 52. The valves 54 are operable to control the type and amount of solvent being drawn from the reservoirs by the pump 50. In some embodiments, the valves 54 comprise solenoid valves that are controlled by a controller and related software and to ensure a proper amount and timing of solvent is released from a reservoir.

The pump 50 is in communication with an additional valve or output valve 58 to control dispensation of fluid(s) to a cartridge 60 and/or a waste collector 62. In some embodiments, the waste collector 62 comprises a vacuum-driven waste collection unit. After an experiment or process is completed, for example, the valves 54 are closed to prevent further flow of fluid(s) from the reservoirs 52. The output valve 58 then permits flow to the waste collector and the pump 50 draws any fluid remaining in the system downstream of the valves 54. The pump and vacuum-driven waste unit draw dead volume fluid and clear the lines and tubes such that the system is prepared for further operations. In some embodiments, a cleaning or rinsing fluid or solvent is provided to purge or clear lines in the system. For example, a quantity of air or carbon dioxide is contemplated as being provided to clear the system and be drawn to the waste collector 62.

Embodiments of the present disclosure, including that shown in FIG. 7, provide the ability to create a mixture of multiple well-proportioned solvents. The embodiment of FIG. 7 provides a solvent mixing system which can create a combination of precisely proportioned solvents from multiple solvent bottles or reservoirs. The solvent bottles are connected to their individual 3-way solenoid valves 54. All the solvent bottles or reservoirs are then combined together with 4:1 or 8:1 (or other) tube connector which merges all the streams from the solvent bottles. The amount and proportion of solvents to be dispensed may be controlled by a controller and software comprising pre-determined or pre-set amounts of fluid for a desired experiment, application, etc.

Although not illustrated in FIG. 7, it is further contemplated that the system 2 comprises a air or gas inlet to provide a fluid and pressure to a headspace of the cartridge 60.

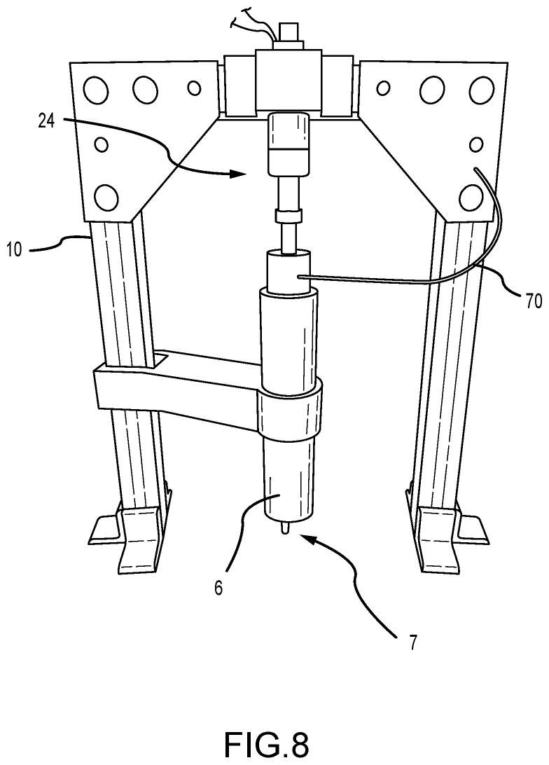

FIG. 8 is a perspective view of a system 2 according to another embodiment of the present disclosure. As shown, the system 2 comprises a frame member 10 for supporting a dispensing device 24 and a cartridge 6. As shown, the dispensing device 24 comprises a motor and a linear actuator to move a seal into contact and sealing engagement with a proximal end of the cartridge. Solvents and gas (e.g., air, nitrogen, etc.) can be provided to the internal volume of the cartridge 6 to perform a SPE process wherein the solvent is filtered through the cartridge and exits the distal end 7 of the cartridge 6.

An inlet 70 is provided to provide a pressure to an internal volume of the cartridge 6. Solvents, such as EtOAc with MgSO4 can be provided within the cartridge and filtered. A fluid (e.g. air or nitrogen) is provided through the air inlet 70. The characteristics of the fluid flow from the inlet 70 and within and through the cartridge are contemplated as being analyzed to determine the conditions and state of materials and processes occurring within the cartridge 6.

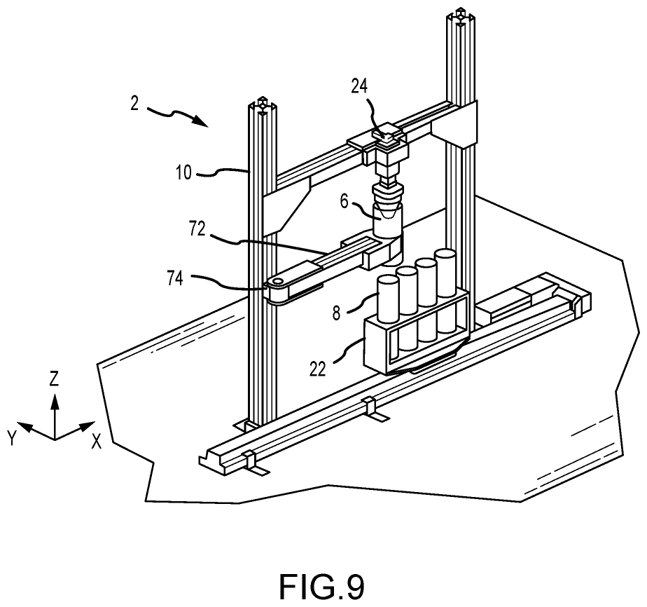

FIG. 9 is a perspective view of a system 2 according to one embodiment of the present disclosure. The system 2 comprises a frame member 10 or similar supporting structure for a dispensing device 24. A cartridge 6 is provided within a distal portion of a pivot arm 72. The pivot arm 72 comprises a hinge 74 provided proximal to the frame 10. The pivot arm 72 is operable to rotate about the hinge 74 to enable and facilitate insertion and replacement of cartridges 6. In some embodiments, including that shown in FIG. 9, the dispensing device 24 comprises a sealing plug having an O-ring and conical member to provide a seal with the cartridge 6. It is further contemplated that a threaded connection is provided on a dispensing device 24 to create a reliable seal between the dispensing device and a cartridge 6. An electrically actuated linear motion slide is provided with the fraction rack 22. The rack 22 is translatable in the X-axis to adjust the position of the multiple fraction vessels 8 provided therein. The dispensing device 24 is contemplated as being operable to seal or substantially seal a proximal end of a cartridge. As used herein, “substantially seal” is contemplated as referring to a sealed state that is imperfect (i.e., some fluid or gas is capable of passing through the seal). One of ordinary skill in the art will recognize that a complete or perfect seal at the proximal end of the cartridge is not required to properly perform and analyze SPE procedures. Accordingly, “seal,” “sealed,” and “substantially sealed” do not necessarily refer to a condition wherein gas or fluid flow is fully or completely prevented.

FIG. 10 is a perspective view of a system 2 according to another embodiment of the present disclosure. As shown, the system 2 comprises various features shown and described herein with respect to other embodiments. The embodiment of FIG. 10 comprises a carousel member 82 that is operable to hold or retain a plurality of cartridge members for use in procedures. The carousel member 82 is rotatable about a vertical, Z-axis such that a plurality of different cartridges can be positioned for communication with a dispensing device. The dispensing device 24 is moveable in a vertical direction (Z-axis) to selectively move the dispensing device in and out of communication with various cartridges. A 4:1 selector valve 78 is provided and a pump 80 is operable to convey fluid from the solvent containers 76 to at least one container. Embodiments of the present disclosure contemplate the provision of a variety of numbers of solvent containers 76. Accordingly, as few as one solvent container may be provided and as many as 24 solvent bottles may be provided. In certain preferred embodiments, between 4 and 10 solvent containers 76 are provided. The selector valve 78 may be varied or replaced based on the number of containers provided with the system 2.

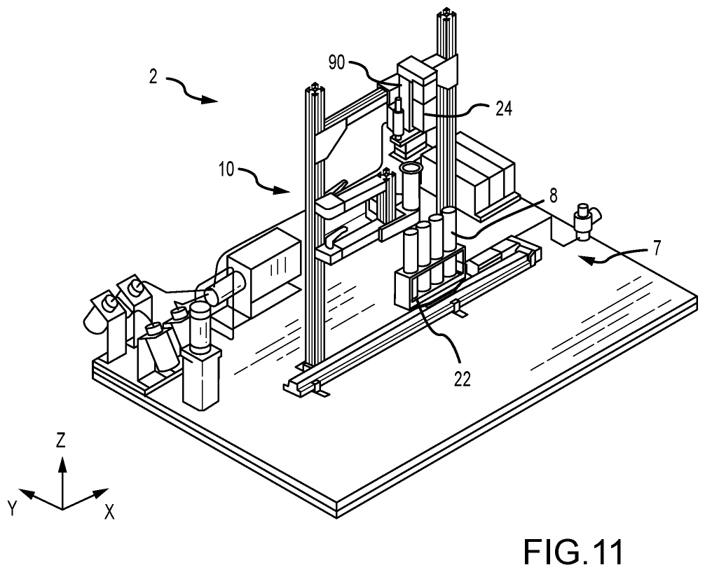

FIG. 11 is a perspective view of a system 2 according to another embodiment of the present disclosure. As shown, a dispensing device 24 is provided. The dispensing device 24 comprises a linear actuator to move a sealing plug. The linear actuator comprises guide rods 90 to ensure a precise and reliable sealing motion with a cartridge. The dispensing device 24 of FIG. 11 is contemplated as comprising a gas conduit 7 for receiving and transmitting fluid (e.g., air or nitrogen) from a source to the dispensing device 24 and ultimately to a headspace of the cartridge.

In various embodiments, a sealing plug is provided that comprises a neoprene plug. Alternatively, the plug is contemplated as comprising a 3D-printed assembly with one or more materials. For example, it is contemplated that a plug is provided on the dispensing device 24 that comprises a mounting flange formed of a first material and an elastic member formed of a second material. The plug is preferably sized and operable to seal cartridges of various diameters.

As shown in FIG. 11, the fraction rack 22 is operable to house four fraction collection tubes 8. A plurality of racks are contemplated as being provided or stacked together and provide the same footprint and dimensions as certain existing products. The fraction racks 22 of the present disclosure is thus operable for use with existing systems including, for example, a BIOTAGE™ V10 evaporator.

Various embodiments of the present disclosure including but not limited to that shown in FIG. 11 contemplate the provision of an air flow sensor to monitor various conditions. For example, it is contemplated that the system 2 comprises an air flow sensor that is operable to monitor and detect when a cartridge is devoid of solvent. The system 2 is then operable to terminate a flow of compressed air and terminate the method or process.

Air and/or fluid flow to the headspace of the cartridge according to various embodiments of the present disclosure provides various features, advantages, and benefits. The provision of this flow to a SPE process or filtration process is contemplated as providing an analytical benefit wherein the flow and/or pressure of air or fluid can be evaluated to determine conditions and events within a cartridge wherein a reaction or process is taking place. In some embodiments, the flow conditions of the air or fluid provided to the cartridge are monitored and analyzed for changes including, for example, the occurrence of a breakthrough condition wherein solvent and a sample have cleared or mostly cleared a cartridge. This occurrence results in a marked and identifiable pressure change event that can be observed without disturbing the sample(s) or procedure.

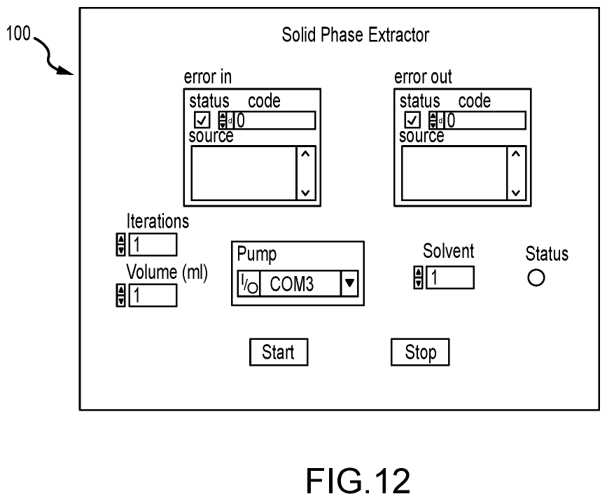

FIG. 12 is a view of a user-interface according to an embodiment of the present disclosure. As shown, the user interface 100 comprises a graphical interface to allow a user to interact with systems of the present disclosure. Specifically, the user interface 100 allows a user to control an operation and capture and visualize data of operations including, for example, a solid phase extraction procedure.

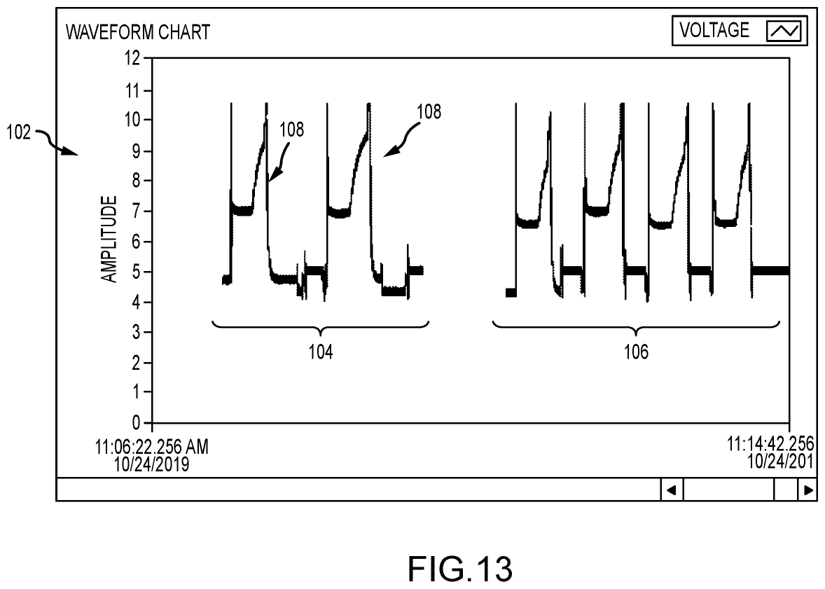

FIG. 13 is a view of an interface and data visualization feature 102 of embodiments of the present disclosure. As shown, systems of the present disclosure are operable to output data regarding air flow dynamics within the system. Specifically, air flow dynamics and pressures within at least one cartridge are output in a graphical format wherein “breakthrough” during a procedure can be determined. First 104 and second 106 runs or procedures are depicted. Determination of a “breakthrough” event is provided and indicated by a pressure drop 108 which signals when a cartridge is available to accept delivery of the next “slug” or dose of solvent to be eluded. Multiple breakthrough events 108 are depicted in FIG. 13 as measured by an airflow sensor of the present disclosure (9 in FIG. 1, for example).

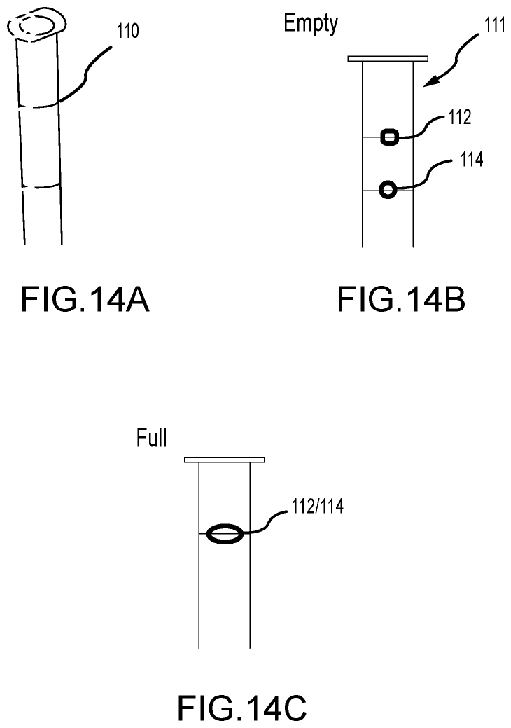

FIGS. 14A-14C are views of systems and methods of the present disclosure for detecting a liquid level within a container using camera and video equipment. As will be recognized by one of ordinary skill in the art, liquid level monitoring and detection is critical to various processes including but not limited to SPE. While various embodiments of the present disclosure contemplate the provision and inclusion of pumps with liquid level detection, methods of detecting fill level using camera devices and related data are contemplated in addition to or in lieu of such pump systems. Embodiments of the present disclosure further contemplate the provision of laser sensors, ultrasonic sensors and similar features to detect fill level. Applicant has discovered that certain methods and systems of detecting fill level, however, suffer from limitations in changing conditions (e.g., changing light, liquid color, viscosity, cartridge transparency conditions). Embodiments of the present disclosure provide for methods of systems of providing one or more cameras, orienting the camera(s) such that it is facing the cartridge and monitoring changes in liquid level in a cartridge in real time. Camera properties and settings are contemplated as being tuned or adjusted to account for changing conditions including but not limited to changing light conditions.

In one embodiment, a method of visual detection of fill level is provided wherein certain physical features of a camera subject are detected and extracted. The method comprises capturing real time video or a plurality of images when a process begins. The process may comprise a SPE process. A liquid level including, for example, a liquid level during a filling process is monitored for the condition in which the fill level meets or exceeds a threshold or predetermined fill level. It is contemplated that the system is operable to stop filling operations upon this condition being met and as detected by the camera. It is contemplated that the overflow or threshold value is determined based on a height or volume of a container being filled (e.g., cartridge). In preferred embodiments, an edge detection technique is employed (e.g., Canny edge detection). Gaussian filtration is applied to remove unnecessary noise in the video or other imaging and an edge detection step is subsequently applied to the captured image(s). The edge detection technique is tuned to lighting conditions such that detection of a top edge of liquid volume is achieved. The resulting imagery or feed is then subjected to a filter (e.g., Sobel filter) to further reduce white noise. A combination of dilation and erosion techniques are contemplated as also being applied to create a distinct and definite edge of the liquid level 110 as shown in FIG. 14A.

As shown in FIG. 14B, a container 111 is provided and a maximum or threshold liquid fill level 112 is provided. The maximum fill level 112 is contemplated as being a predetermined value based on, for example, the volume or shape of the container 111, container-manufacturer recommendations, and/or the specific procedure being performed. An actual or present liquid fill level 114 is provided and detected by the camera. The actual liquid level 114 is preferably tracked in real time by the system. When the actual level 114 reaches the maximum level 112 (FIG. 14C), a signal is provided to the pump to terminate liquid pumping operations. In some embodiments, the video feed resolution of the system is not high-definition and the system is running on low-latency which enables highly accurate and real-time liquid level detection.

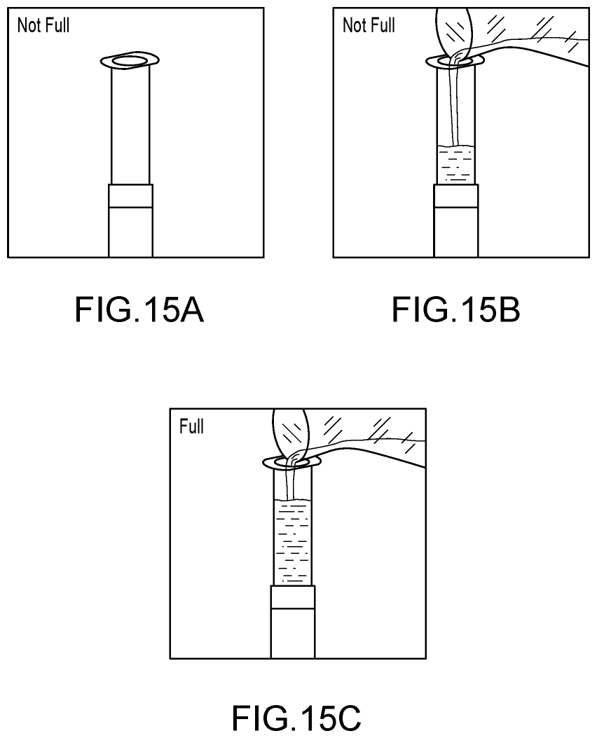

In various embodiments, machine learning systems and algorithms are contemplated for object detection, classification, etc. Machine learning is provided in various embodiments of the present disclosure to provide highly accurate and responsive termination of liquid pumping when a fill level condition has been met (for example). Embodiments of the present disclosure contemplate providing a machine learning model that is operable to differentiate between various different fill level states of a cartridge or container. An algorithm is contemplated that comprises a convolution neural network (“CNN”) trained on a data set of different cartridge fill level conditions and other conditions including, for example, lighting conditions. A manual data set is contemplated as being provided, and a system is provided with inputs and information including examples of “Not Full” (FIGS. 15A-15B) and “Full” (FIG. 15C) conditions. Preferably, different lighting conditions, liquid densities, liquid colors, container opacities, etc. are provided at least an initial basis for a system to “learn” and observe full and not-full conditions of a container. The system is operable to provide a signal or otherwise convey information regarding the fill state and terminate a flow of solvent (for example) when a full condition (FIG. 15C) has been achieved.

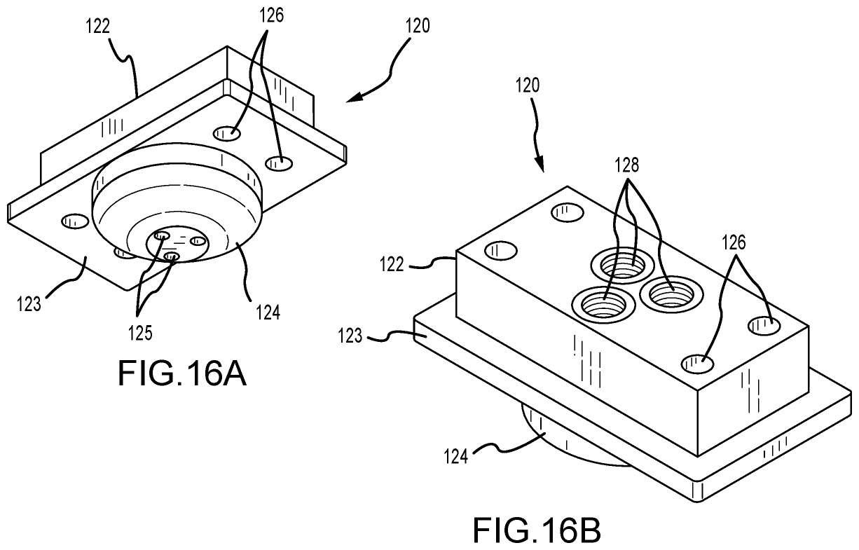

FIG. 16A is a perspective view of a component 120 of a dispensing device for use with various embodiments of the present disclosure. As shown, the component 120 comprises a base 122, a support plate 123, and a distal tip 124. The distal tip 124 is operable to receive and support a sealing element or plug (not shown in FIG. 16A, but see 136 of FIG. 18). A plurality of apertures 126 are provided that are operable to receive fasteners and secure the component 120 to a system according to various embodiment of the present disclosure. The support plate 123 and distal tip 124 are contemplated as comprising highly chemically-resistive elements. In some embodiments, at least the support plate 123 and distal tip 124 comprise at least one of Kalrez and silicone. A plurality of dispensation ports 125 are provided that are operable to dispense and convey material (e.g., fluid) from a source to an internal volume of a sealed or substantially sealed container. Although three ports 125 are shown in FIG. 16A, no limitation with respect to the number of ports is provided. It is contemplated that as few as one port may be provided, or a plurality comprising 5 or more ports are provided.

FIG. 16B is a top perspective view of the component 120 of FIG. 16A. As shown, a plurality of apertures 128 are provided on a proximal side of the component 120. The apertures 128 are operable to convey fluid through the component 120 and into an internal volume of a container. The apertures 128 are depicted as threaded female apertures in FIG. 16B. It should be recognized that alternative arrangements including non-threaded apertures are contemplated. The apertures 128 are contemplated as receiving Teflon tubing to convey fluid to and through the component. In some embodiments, a first aperture is operable to receive and transmit a solvent as an eluent; a second aperture is operable to receive and transmit nitrogen gas; and a third aperture is operable to serve as an overflow diverter port in the event of an overfill or overflow of a headspace of a container. In alternative embodiments, additional ports are provided. In further alternative embodiments, only a single port is provided and a split or bifurcation of plumbing and materials is provided upstream of the component 120 (for example).

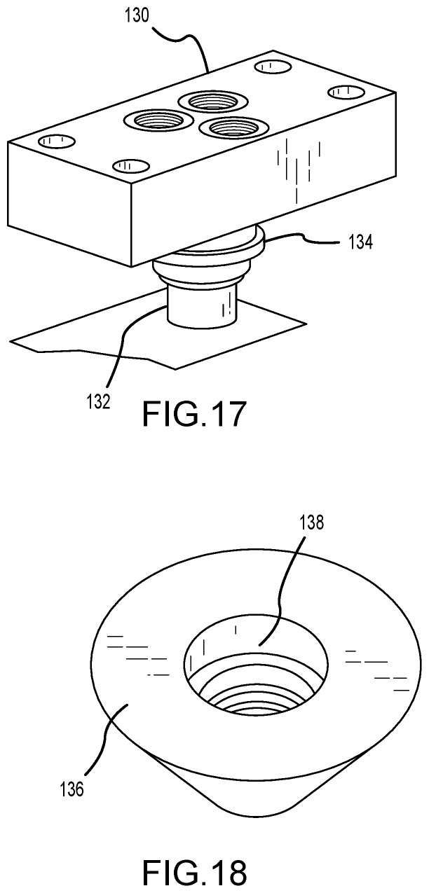

FIG. 17 is a perspective view of a component 130 for receiving and supporting a plug and related features according to another embodiment of the present disclosure. As shown, the component 130 comprises a base or support member and a distal tip 132 for receiving and supporting a plug. The distal tip 132 comprises a one or more ribs or protrusions for receiving and securing a plug. It is contemplated that the component 130 comprises one or more of aluminum, PEEK, or glass-impregnated polypropylene, although no limitation with respect to the material of the component 130 is provided herewith.

FIG. 18 is a perspective view of a plug 136 contemplated use with various embodiments of the present disclosure. As shown, the plug 136 comprises a conical or frustoconical element operable to partially extend into an opening of a container and seal a rim or open end of the container. The plug 136 comprises an internal channel or conduit for receiving and conveying fluid(s). One or more ribs 138 are provided that preferably correspond to and communicate with the one or more ribs 134 of the component 130 of FIG. 17. The plug 136 is contemplated as being formed from 3D-printed thermoplastic polyurethane and/or chemically resistant silicone.

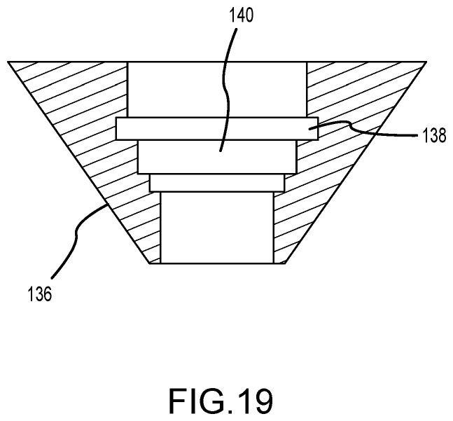

FIG. 19 is a cross-sectional elevation view of a plug 136 according to an embodiment of the present disclosure. As shown, the plug 136 comprises a central aperture 140 or passage through which one or more fluids can be conveyed. At least one annular void or rib 138 is provided to receive additional components and secure the plug. Although a smooth outer conical or frustoconical surface is shown in FIG. 19, it is also contemplated that plug members of the present disclosure comprise a scallop or ridge to provide a stable and reliable seal.

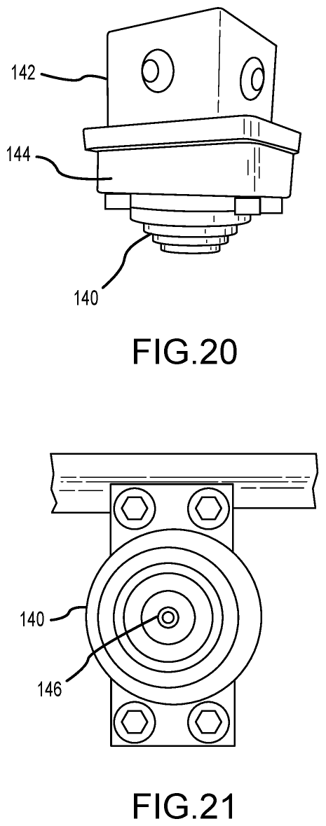

FIGS. 20-21 are views of a plug 140 according to one embodiment of the present disclosure shown in combination with and assembled with a base 142 and support plate 144. The assembled components (140, 142, 144) are collectively translatable as part of a dispensing device as shown and described herein. The plug 140 of FIGS. 20-21 comprise a scalloped outer surface with a plurality sections having distinct diameters to accommodate containers of different sizes. As shown in FIG. 21, a port 146 is provided on a lower, distal portion of the plug to convey fluid to a container. The port 146 of the device of FIG. 21 is contemplated as comprising a gas flow port for use in manual procedures. For example, the gas flow port 146 is contemplated as comprising a means to convey nitrogen gas to pressurize a container and it contemplated that solvent(s) is supplied manually and separately. It will be recognized, however, that the embodiments of FIGS. 20-21 are also contemplated as comprising a plurality of ports including ports for providing solvent through the plug 140 and/or providing an overflow port through the plug. 140.

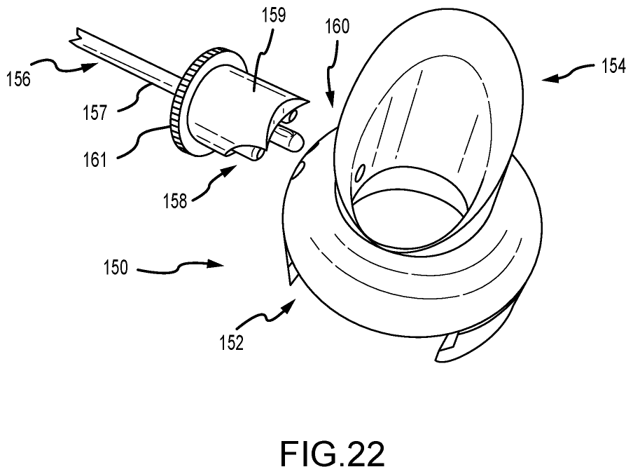

FIG. 22 is a perspective view of a system according to an embodiment of the present disclosure that comprises a dispensing cap 150 for use in various processes. The cap 150 comprises a device that is operable to be attached (e.g. via snap-fit or threading) to various containers, vials, and other devices. In various embodiments, including that shown in FIG. 22, the cap 150 comprises an open-ended device operable to pour contents (e.g. liquid contents). It is contemplated, however, that the cap 150 comprises and/or is provided with a sealing member to selectively secure and close the cap 150. The cap 150 comprises a base member 152 that is operable to communicate with various additional system components. An upper portion of the cap 150 comprises a spout 154 to enable and facilitate the pouring or egress of liquids from or through the cap 150. The spout 154 extends upwardly from the base member 152. The base member 152 further comprises apertures 160 operable to receive and connect to a support and actuation member 156. In various embodiments, the actuation member 156 comprises a post or similar support that is operable to at least one of: connect to, lift/translate, and rotate a cap 150 and any associated container. In various embodiments, and as will be described herein, at least a portion of the actuation member is operable to remain in a fixed rotational position while moving in at least two axes to lift and translate the cap 150, for example. Such features and embodiments are contemplated as being useful for rinsing a container and/or cap 150.

As shown in FIG. 22, the actuation member 156 comprises a cannula 157. The cannula is operable to remain in a fixed rotational position in various embodiments and generally does not rotate about its longitudinal axis during use. A cap receiving portion comprises at least one and preferably more than one post 158 that extends into one or more apertures 160 in the cap 150. The cap receiving portion and post(s) 158 are operable to rotate with the cap as the cap 150 is lifted and tilted, for example. The cannula 157 preferably comprises an aperture in its distal end that is positioned in an opening of the spout 154 when fully assembled. A gear or collar 161 is contemplated as being provided to enable rotation of the cap receiving portion and the cannula is operable to rotate within the gear and cap receiving portion via a bearing, bushing, or similar rotational element.

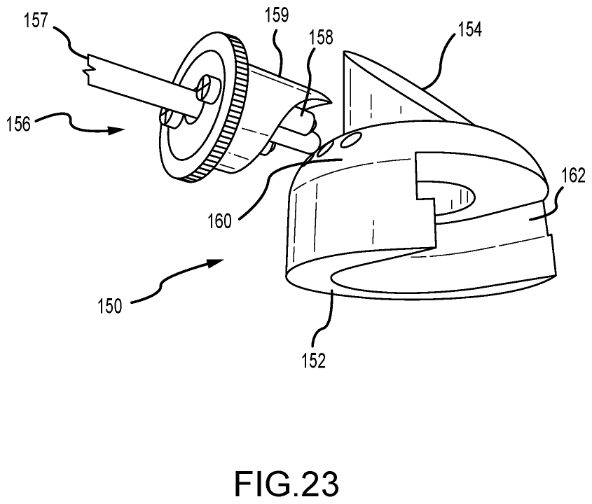

FIG. 23 is a bottom perspective view of the pouring and dispensing system. As shown, the cap 150 comprises a base member 152 and a spout 154. The base member 152 comprises a receiving area for a container include a slot 162 and a C-shaped or partially open portion to selectively receive a container or similar element. The cap 150 is FIG. 23 illustrates one particular embodiment but it will be recognized that alternative embodiments are contemplated. For example, it is contemplated that the cap 150 comprises a threaded member operable to be threaded onto a container or similar member.

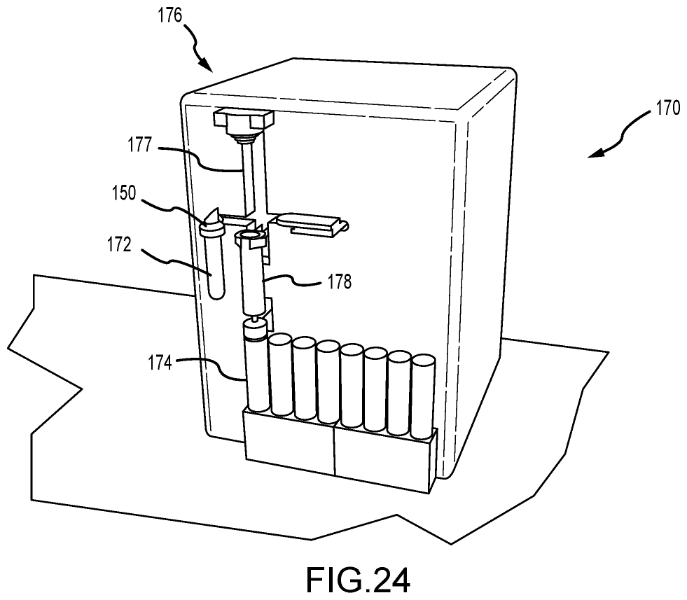

FIG. 24 is a perspective view of a system 170 for use with benchtop processes and reactions including, for example, SPE applications. A benchtop cabinet 176 is provided and is contemplated as housing, containing and/or controlling various components including, for example, liquid storage, pumps, and controls. The system 170 comprises a container 172 comprising a cap 150 according to various embodiments shown and described herein. The system 170 is operable to selectively convey or dispense contents from a first container 172 to a second container 178 (e.g. a SPE container) and the second container 178 is operable to dispense contents to one or more additional containers 174. While various embodiments of the present disclosure are contemplated for use with SPE methods, it should be recognized that no limitation with respect to the intended process(es) is provided herewith. Indeed, various features including but not limited to cap members of the present disclosure are operable and contemplated for use with any process or system that requires liquid transfer or dispensing. A linkage 177 or similar mechanism is provided and is operable to actuate and automatically dispense liquid at least from the first container 172 to the second container 178.

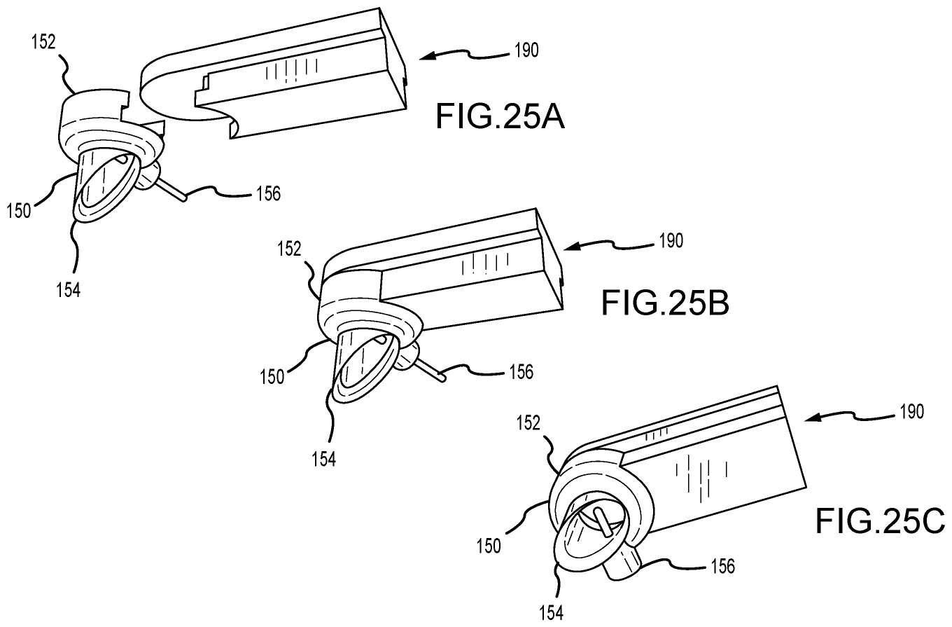

FIG. 25A is a perspective view of a cap member 150 and a rinsing cap 190 according to an embodiment of the present disclosure. The cap member 150 is shown in inverted position at least with respect to FIG. 22 and the container is removed. The depicted rinsing cap 190 and associated methods of use are contemplated to clean or rinse solvent-exposed surfaces of a cap member 150. As shown, the base member 152 of the cap 150 is operable to slidably receive the rinsing cap 190. The actuation member 156 comprises a cannula with at least one aperture provided within the cap (FIG. 25C). The cannula and aperture are operable to convey or dispense a cleaning fluid (e.g. air, saline, etc.) to an interior of the cap. The rinsing cap 190 is operable to cover and/or deflect cleaning fluid and generally contain the cleaning fluid to specific areas. The cannula of the actuation member 156 is preferably provided in a rotationally fixed position wherein the cap 150 is operable to rotate about the cannula but the cannula does not rotate about its own longitudinal axis. While various embodiments of the present disclosure contemplate a single aperture in the cannula, alternative embodiments contemplate a plurality of apertures that are collectively operable to spray or dispense fluid in multiple directions.

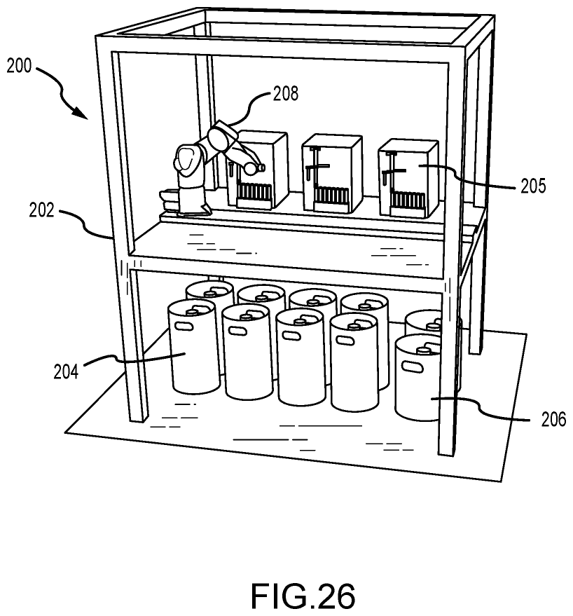

FIG. 26 is a perspective view of a system according to an embodiment of the present disclosure. As shown, the system 200 is contemplated as comprising an automated SPE system comprising a rack 202, multiple SPE modules 205, clean fluid containers 204 (e.g. 20 liter solvent containers), waste fluid containers 206 (e.g. 20 liter waste containers), and an integrated six-axis robot 208 on a track to programmatically address each SPE module 205.

The clean fluid containers 204 are contemplated as being in fluid communication with at least one SPE module 205 and are operable to transfer fluid to the module(s) for use in reactions. The SPE modules are contemplated as comprising at least one pump to convey fluid. The waste containers 206 are also contemplated as being provided in fluid communication with at least one SPE module 205. Fluid may be pumped or gravity-fed to the waste containers 206.

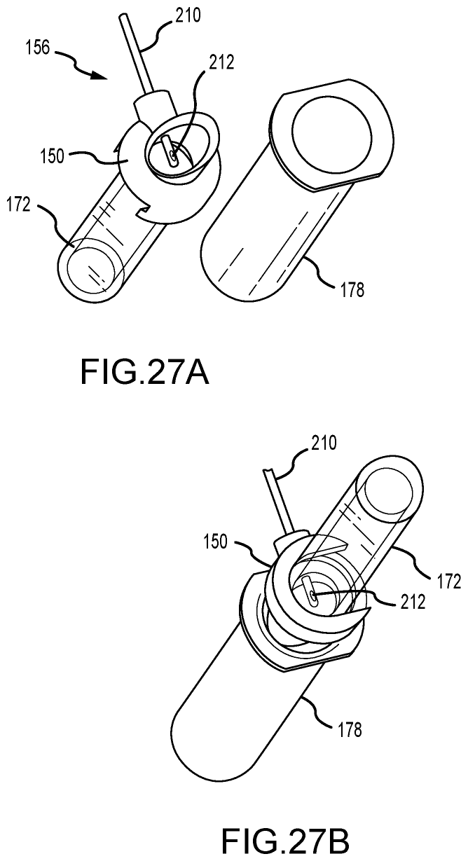

FIGS. 27A-27B are top perspective views of a system according to an embodiment of the present disclosure. As shown, a dispensing cap 150 is provided in combination with a first container 172. A second container 178 is provided and it is contemplated and intended that contents of a first container 172 are transferred to the second container 178. An actuation member 156 is provided that comprises a cannula 210 or similar conduit member with at least one aperture 212 provided at a distal end thereof and operable to be provided within the cap member 150. A bushing 214 is provided that is operable to connect to the cap 150 and allow rotation of the cap 150 and container 172 relative to the cannula 210. As shown in FIGS. 27A and 27B, the cannula 210 is operable to remain rotationally fixed about its longitudinal axis and the aperture 212 remains in substantially the same position when the container is rotated. The aperture 212 is operable to convey and spray a fluid to a container 172 or cap 150 to rinse or clean the components.

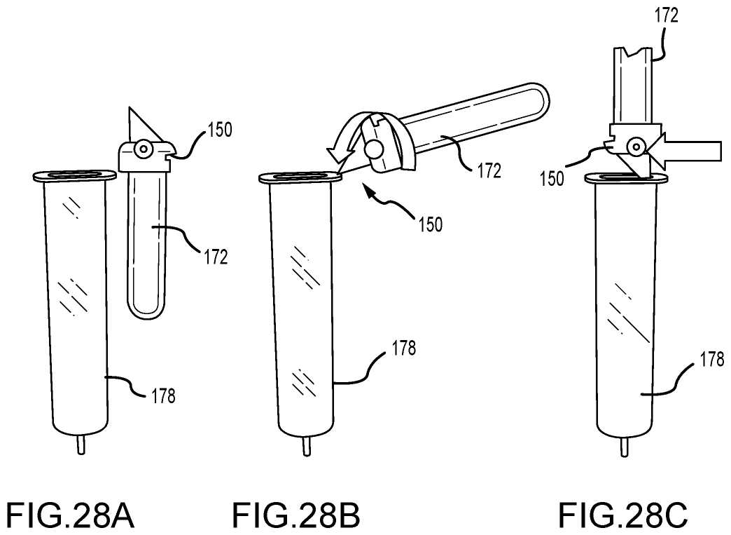

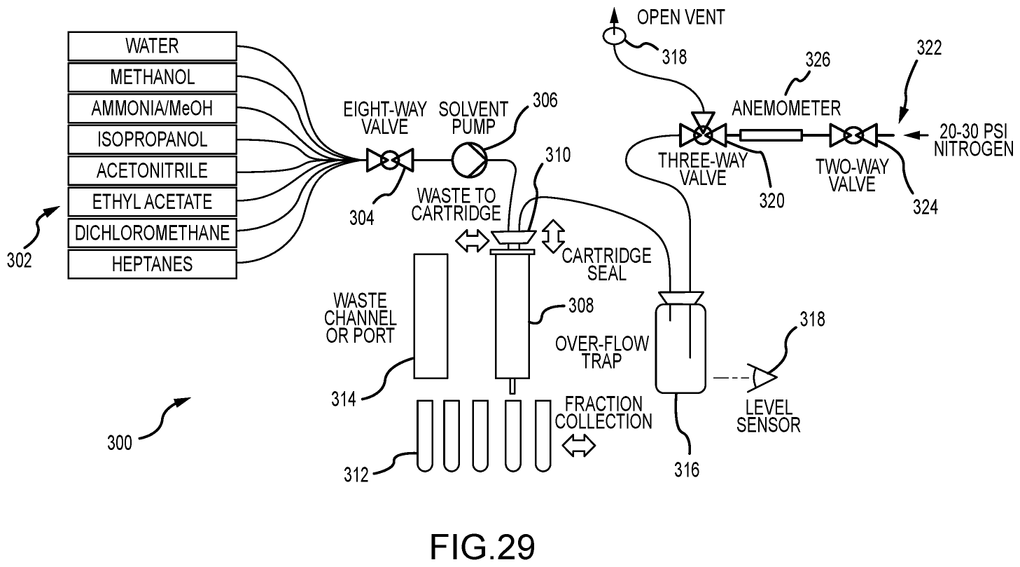

FIGS. 28A-28C illustrate a pouring and dispensing system of the present disclosure wherein a cap 150 is provided in association with a container 172 and a second container 178 is provided. As shown in FIG. 28A, the cap and first container 172 are operable to rotate. The cap and container must be provided in close proximity to the second container 178, while being spaced apart by a sufficient distance to avoid physical interference between the components. FIG. 28B illustrates an undesirable arrangement wherein the first container 172 and associated cap 150 are spaced apart from the second container 178 by an excessive distance. It is contemplated in various embodiments that the container and cap are operable to rotate but not translate. Accordingly, the arrangement and spacing shown in FIG. 28B will result in misalignment of certain components and likely spilling of liquid or other contents without rotation. FIG. 29C illustrates an embodiment wherein the container 172 and cap 150 are rotated approximately 180 degrees and a horizontal translation is also performed to align system components. Various embodiments contemplate pouring operations being achieved by a combination of rotational and translational movement. Such motion(s) is contemplated as being achieved by various mechanisms including, for example, linkages, robotics, and various automated means as well by human contact and use.

FIG. 29 is a schematic view of a system 300 according to an embodiment of the present disclosure. As shown, the system 300 comprises a plurality of reservoirs 302. The reservoirs 302 are operable to house and store fluids including, for example, solvents. Contents and fluid contemplated as being housed in the one or more reservoirs 302 include but are not limited to water, methanol, ammonia, isopropanol, acetonitrile, ethyl acetate, dichloromethane, and heptanes. A valve 304 is provided and a pump 306 is operable to convey fluid(s) from the reservoir(s) 302 to a reaction vessel 308. A seal 310 as shown and described in various embodiments provided herein is operable to selectively seal the vessel 308. One or more fraction collection vessels 312 are provided to collect materials from the vessel 308. A waste cartridge 314 is provided in certain embodiments. The seal or plug 310 comprises an inlet and an outlet and the outlet is in fluid communication with an over-flow trap 316. A level sensor 318 including, for example, an optical level sensor is contemplated as being provided to monitor over-flow container. The over-flow trap or container 316 is in communication with a vent 318 via a valve 320. A gas inlet 322 is further provided, and gas flow is contemplated as being controlled and measured by a valve 324 and a flow sensor 326 (e.g. an anemometer), respectively. The system of FIG. 29 is contemplated as comprising various components disclosed herein. For example, the seal depicted in FIG. 29 may comprise one or more seals shown and described herein. Further, a benchtop SPE module as shown in FIG. 24 is contemplated as being incorporated into the system of FIG. 29 and may contain and house the valve 304, pump 306 and additional elements. A cartridge holder including, for example, that shown in FIG. 2, is contemplated as being provided to accommodate the vessel 308 and a modular rack assembly (FIGS. 6A-6C, for example) is contemplated as being provided for the fraction collection vessel(s) 312.

It is to be understood that the disclosure is not limited to particular methods or systems, which can, of course, vary. It is also to be understood that the terminology used herein is for the purpose of describing particular embodiments only and is not intended to be limiting.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A system for performing solid phase extraction procedures, the system comprising:
a cartridge for receiving at least one of a solid and a liquid, the cartridge being selectively provided on and supported by a support member;
a dispensing device that is operable to dispense a fluid to an interior volume of the cartridge;
a sealing member operable to provide a substantially gas-impermeable seal to a proximal end of the cartridge;
a plurality of fluid reservoirs that are each operable to house and dispense a fluid;
a pump operable to convey fluid from the plurality of fluid reservoirs to the dispensing device; and
a translatable rack operable to house a plurality of containers that are operable to receive fluid from the cartridge.

2. The system of claim 1, wherein the dispensing device is provided on the support member.

3. The system of claim 1, wherein the dispensing device is vertically translatable.

4. The system of claim 1, wherein at least one of the fluid reservoirs comprises a solvent for use in solid phase extraction.

5. The system of claim 1, further comprising a waste collector operable to receive a volume of fluid.

6. The system of claim 5, further comprising at least one valve provided between the plurality of fluid reservoirs and the waste collector.

7. The system of claim 1, wherein the translatable rack is translatable in a horizontal direction.

8. The system of claim 1, further comprising at least one of an air flow sensor and a pressure sensor operable to determine a condition within an internal volume of the cartridge.

9. A method of solid phase extraction, the method comprising:
providing an empty cartridge and a fraction carrier comprising a plurality of empty fraction vessels;
detecting the presence of the cartridge;
detecting the presence of the fraction vessels;
indexing the system to the first fraction vessel;
introducing a sample into the cartridge;
inputting a signal;
pressurizing the cartridge to clear a headspace of the cartridge;
providing a solvent to the cartridge;
monitoring an internal pressure value of the cartridge.

10. The method of claim 9, wherein the step of monitoring comprising monitoring using a pressure sensor and a controller.

11. The method of claim 9, wherein digital images of the cartridge are monitored to determine when a desired amount of solvent has been provided.

12. The method of claim 11, wherein the system automatically terminates a flow of the solvent based on the monitoring step.

13. A method of detecting fill level of a container, the method comprising:
providing a container having a volume;
determining a maximum fill level of the container;
providing a camera;
capturing images of the container using the camera;
providing a fluid to the volume of the container;
performing an edge detection technique to the images;
applying a filter to the images; and
identifying an actual fill level of the container.

14. The method of claim 13, further comprising applying Gaussian filtration to the images prior to the edge detection technique.

15. The method of claim 13, further comprising a step of comparing the actual fill level to the maximum fill level.

16. The method of claim 15, wherein a signal is provided to terminate fluid flow to the container when the actual fill level is equal to or greater than the maximum fill level.

17. A dispensing cap system comprising:
a cap member having a base and a spout;
the spout being operable to pour or dispense a fluid;
the base comprising a receiving portion to receive a fluid container; and
an actuation member operable to connect to the base of the cap member, wherein a portion of the actuation member is fixed to the cap and operable to rotate with the cap and wherein the actuation member further comprises a rotationally fixed conduit.

18. The dispensing cap system of claim 17, wherein the rotationally fixed conduit comprises a fluid conduit with a dispensing aperture provided at a distal end thereof.

19. The dispensing cap system of claim 17, wherein the base comprises a connection member for a receiving a fluid container.
